(19) United States
(12) Patent Application Publication
(10) Pub. No.: US 2006/0263568 A1
(43) Pub. Date: Nov. 23, 2006

(54) Optical recording medium

(75) Inventor: Kuo-Hsin Teng, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/384,547

(22) Filed: Mar. 21, 2006

(30) Foreign Application Priority Data
May 20, 2005 (TW) 094116467

(51) Int. Cl. B32B 3/02

(52) U.S. Cl. 428/64.4

(57) ABSTRACT

An optical recording medium includes a first substrate, a second substrate and a reflective layer. In this case, the second substrate includes a thermochromic dye. The reflective layer is disposed between the first substrate and the second substrate.

### BACKGROUND OF THE INVENTION

1. Field of Invention

The invention relates to an optical recording medium and, in particular, to an optical recording medium with a thermochromic dye.

2. Related Art

Due to the progress of multimedia, the demands of storage medium in 3C products, i.e. computer, communication and consumer, regarding to storage density and capacity are increasing. Conventional storage medium could be divided into magnetic information storage medium and optical information storage medium. Optical information storage medium is greatly applied to electronic products, it includes the read-only CD (CD-ROM), write-once CD (CD-R), rewritable CD (CD-RW), read-only DVD (DVD-ROM), write-once DVD (DVD-R), rewritable DVD (DVD-RW, DVD+RW), random-access DVD (DVD-RAM), high definition DVD (HD-DVD), blu-ray disc (BD), etc.

Referring to FIG. 1, a conventional optical recording medium 1, such as a CD-ROM, includes a substrate 11, a reflective layer 12, and a protective layer 13. The substrate 11 having pre-grooves is made of polycarbonate and is formed with an injection molding machine. The reflective layer 12 is disposed over the substrate 11 and is made of metal or alloy such as silver or silver alloy, aluminum or aluminum alloy, or gold or gold alloy. The reflective layer 12 is usually formed by sputtering or evaporation. The optical recording medium 1 can reflect the laser light with the reflective layer 12, and then the digital data recorded in the optical recording medium 10 can be read.

To protect the reflective layer 12 from oxidation or being scratched, the protective layer 13 is usually disposed on the reflective layer 12. The protective layer 13 is made of acrylic resin monomer. After irradiated with UV light, the acrylic resin monomer can be polymerized and hardened so as to protect the reflective layer 12.

To attract costumers' attention, the manufacturers of optical recording media work hard on the development of attractive products, which can increase the market share. Therefore, some manufacturers print the ink of different colors on the protective layer 13, and then use UV light to irradiate the ink to form a printing layer 14. Thus, the appearance of the optical recording medium is more beautiful so as to cause the purchases of customers, and the product competitiveness can be increased.

However, the above-mentioned method only changes the color of the appearance without any other additional effect. If the optical recording medium can provide an alerting function by showing different colors, patterns or words at different temperatures, the customers can easily determine whether the environmental condition is suitable for storing the optical recording medium or not. For example, if the environmental condition is unsuitable, the warning symbol will appear on the optical recording medium. This novel function is useful and can provide better entertainment and uniqueness so as to cause the purchases of customers.

Therefore, it is an important subject of the invention to provide a novel optical recording medium that can provide a warning function by showing various colors at different environment temperatures.

### SUMMARY OF THE INVENTION

In view of the foregoing, the invention is to provide an optical recording medium including a thermochromic dye.

To achieve the above, an optical recording medium of the invention includes a first substrate, a second substrate and a reflective layer. In the invention, the second substrate includes a thermochromic dye, and the reflective layer is disposed between the first and second substrates.

To achieve the above, the invention discloses an optical recording medium, which includes a substrate, a reflective layer and a printing layer. In the invention, the reflective layer is disposed on a surface of the substrate, and the printing layer is disposed on a surface of the reflective layer. The printing layer includes a thermochromic dye.

To achieve the above, the invention also discloses an optical recording medium, which includes a cover layer, a substrate, and a reflective layer. In the invention, the substrate includes a thermochromic dye and the reflective layer is disposed between the cover layer and the substrate.

As mentioned above, the optical recording medium of the invention utilizes a thermochromic dye to detect whether it is located in an unsuitable environment or not. When the environmental temperature is unsuitable, the warning symbol appears on the optical recording medium for alerting the user. In addition, since the optical recording medium of the invention can show different colors in different environmental temperatures, it can provide better entertainment and uniqueness so as to cause the purchases of customers.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional optical recording medium;

FIG. 2 is a top view of an optical recording medium according to a preferred embodiment of the invention;

FIG. 3 is a sectional diagram of the optical recording medium taken along the doted line a-a′ of FIG. 2;

FIG. 4 is a top view of an optical recording medium according to another preferred embodiment of the invention;

FIG. 5 is a sectional diagram of the optical recording medium taken along the doted line b-b′ of FIG. 4;

FIG. 6 is a top view of an optical recording medium according to yet another preferred embodiment of the invention; and

FIG. 7 is a sectional diagram of the optical recording medium taken along the doted line c-c′ of FIG. 6.

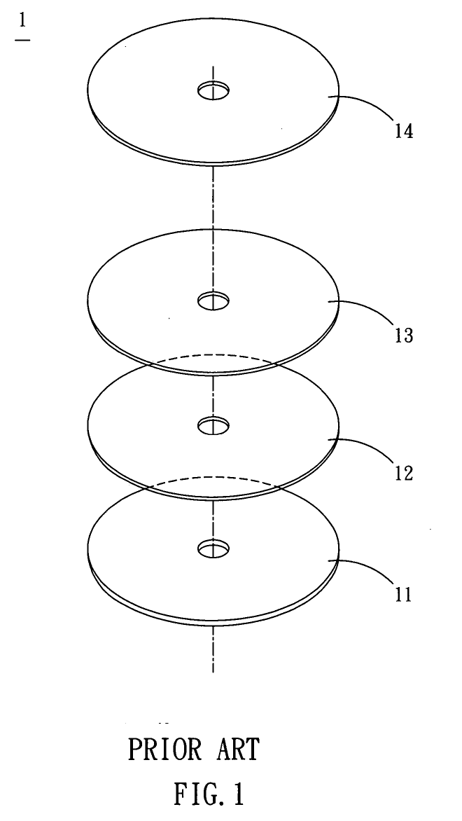

### DETAILED DESCRIPTION OF THE INVENTION

The present invention will be apparent from the following detailed description, which proceeds with reference to the accompanying drawings, wherein the same references relate to the same elements. In the invention, the optical recording medium can be a CD-ROM, a CD-R, a CD-RW, a DVD-ROM, a DVD±R, a DVD±RW, a DVD-RAM, an HD-DVD, or a Blu-ray disc.

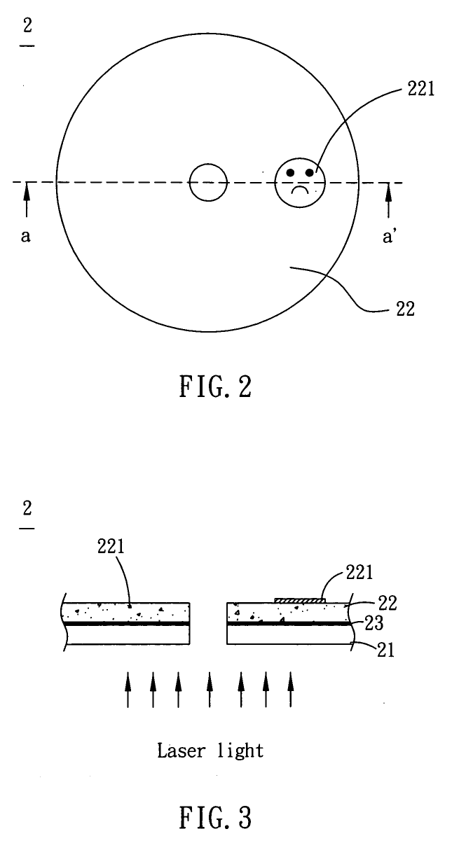

FIG. 2 is a top view of an optical recording medium according to a preferred embodiment of the invention, and FIG. 3 is a sectional diagram of the optical recording medium taken along the doted line a-a′ of FIG. 2. In this embodiment, the optical recording medium is a DVD-ROM. With reference to FIGS. 2 and 3, an optical recording medium 2 includes a first substrate 21, a second substrate 22 and a reflective layer 23.

The first substrate 21 is a transparent substrate with a thickness of approximate 0.6 mm. The first substrate 21 is, for example, made of plastic materials such as acrylic, polycarbonate (PC), or acrylonitrile-butadiene-styrene (ABS). For forming the first substrate 21, the plastic material is applied in an injection molding process with a stamper having data pits and grooves. The optical recording medium 2 records digital data based on the data pits, which can be read with the laser light.

The second substrate 22 includes a thermochromic dye 221, which is doped in the second substrate 22. The thickness of the second substrate 22 is approximate 0.6 mm. In this embodiment, the thermochromic dye 221 may be composed of CoCl2-2C6H12N4-10H20, HgI2, or thermochromic microcapsule dye. Thus, the thermochromic dye 221 may change its color based on the temperature. That is, the thermochromic dye 221 can repeatedly change its color according to the up or down of the environmental temperature. For example, when the temperature rises to 35° C., the thermochromic dye 221 made of CoCl2-2C6H12N4-10H20 will lose the crystal water and its color thus turns into sky-blue. Then, when the temperature decreases, it will absorb the moisture in the air and recovers its original color. In another case, when the temperature rises to 137° C., the thermochromic dye 221 made of HgI2 will transform from the red cubic crystal to the cyan orthorhombic crystal. Then, when the temperature returns to the room temperature, it will transform back to the red cubic crystal.

In the embodiment, a microcapsule process is applied to encapsulate the thermochromic dye as the thermochromic microcapsule dye. The present thermochromic microcapsule includes the thermochromic power, the thermochromic emulsion, and thermochromic plastic pigment particle. The thermochromic power and thermochromic plastic pigment particle are soluble in organic solvent, and the thermochromic emulsion is water soluble. Regarding to the color change conditions, the thermochromic microcapsule dye includes the cold transfer type, the heat transfer type, and other type. The thermochromic microcapsule dye of the cold transfer type shows its original color in low temperature, and becomes colorless when the temperature rises to room temperature. The thermochromic microcapsule dye of the heat transfer type shows its original color in room temperature, and becomes colorless when the temperature rises. The thermochromic microcapsule dye of the other type shows different colors at different temperatures.

In this embodiment, the thermochromic dye 221 is mixed with plastic particles, and then the mixture is processed with an injecting molding machine to fabricate the second substrate 22 with the thermochromic dye 221. Of course, the second substrate 22 may be doped with several thermochromic dyes 221, so that the second substrate 22 may have various color changes at different temperatures so as to provide better entertainment. Herein, the thermochromic dye 221 is approximate 0.1 to 0.3% of the second substrate 22.

The reflective layer 23 is disposed between the first substrate 21 and the second substrate 22. In the current embodiment, the reflective layer 23 is made of metal or alloy, such as silver or silver alloy, aluminum or aluminum alloy, gold or gold alloy, semiconductor alloy film, and the likes. The reflective layer 23 is usually formed by sputtering or evaporation.

Alternatively, the thermochromic dye 221 may be printed on a surface of the second substrate 22. In detailed, the thermochromic dye 221 is mixed with ink, and then the mixture is printed on the surface of the second substrate 22 to form a pattern or word. In this case, the formed pattern is a crying face. Herein, the thermochromic dye 221 is approximate 1 to 10% of the ink.

In the present embodiment, the thermochromic dye 221 doped in the second substrate 22 is colorless at room temperature, and it transfers to red when the environment temperature rises. Accordingly, if the optical recording medium 2 is placed in the high temperature condition, the second substrate 22 will turn to red so as to show the crying face on the optical recording medium 2. The users can easily determine whether the environment temperature is suitable for storing the optical recording medium 2 or not and whether the environment temperature leads to the damage of the optical recording medium 2 or not.

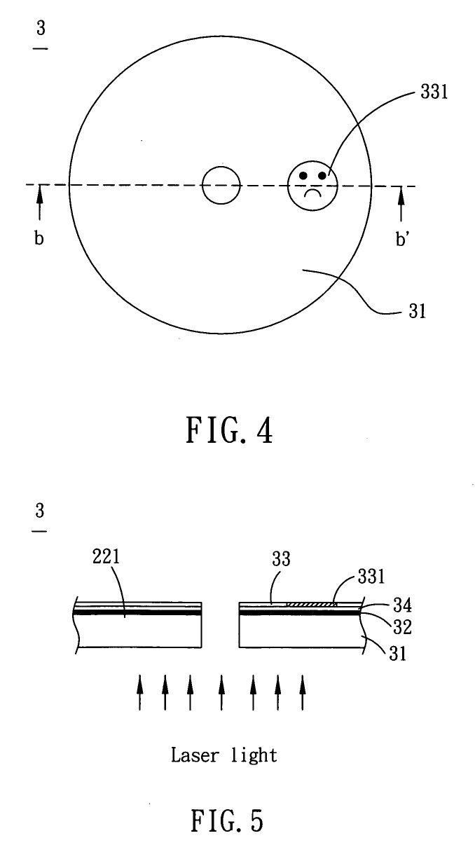

FIG. 4 is a top view of an optical recording medium according to another preferred embodiment of the invention, and FIG. 5 is a sectional diagram of the optical recording medium taken along the doted line b-b′ of FIG. 4. In this embodiment, the optical recording medium is a CD-ROM. With reference to FIGS. 4 and 5, an optical recording medium 3 includes a substrate 31, a reflective layer 32, and a printing layer 33.

The substrate 31 is a transparent substrate with a thickness of approximate 1.2 mm. The substrate 31 is, for example, made of plastic materials such as acrylic, polycarbonate (PC), or acrylonitrile-butadiene-styrene (ABS). For forming the substrate 31, the plastic material is applied in an injection molding process with a stamper having data pits and grooves. The optical recording medium 3 records digital data based on the data pits, which can be read with the laser light.

The reflective layer 32 is disposed on a surface of the substrate 31. In the current embodiment, the reflective layer 32 is made of metal or alloy, such as silver or silver alloy, aluminum or aluminum alloy, gold or gold alloy, semiconductor alloy film, and the likes. The reflective layer 32 is usually formed by sputtering or evaporation.

The printing layer 33 includes a thermochromic dye 331. In detailed, the thermochromic dye 331 is mixed with ink, and then the mixture is printed on the surface of the reflective layer 32 to form, for example, a crying face. Furthermore, to protect the reflective layer 32 from oxidation or being scratched, a protective layer 34 is usually disposed between the printing layer 33 and the reflective layer 32.

If the optical recording medium 3 is placed in the high temperature condition, the crying face appears on the optical recording medium 3. Thus, the users can easily determine whether the environment temperature is suitable for storing the optical recording medium 3 or not and whether the environment temperature leads to the damage of the optical recording medium 3 or not.

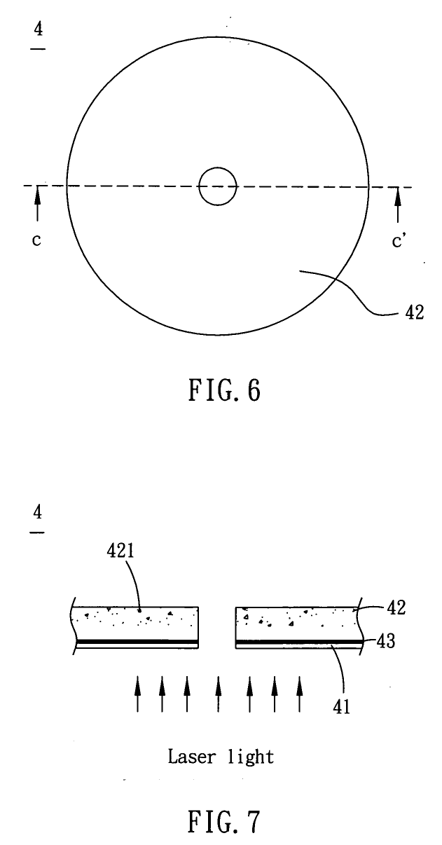

FIG. 6 is a top view of an optical recording medium according to yet another preferred embodiment of the invention, and FIG. 7 is a sectional diagram of the optical recording medium taken along the doted line c-c′ of FIG. 6. In this embodiment, the optical recording medium is a Blu-ray disc (BD). With reference to FIGS. 6 and 7, an optical recording medium 4 includes a cover layer 41, a substrate 42, and a reflective layer 43.

The substrate 42, which is also a protection layer, is doped with a thermochromic dye 421. The substrate 42 has a thickness of approximate 1.1 mm. For forming the substrate 42, the thermochromic dye 421 and the plastic material are mixed and then applied in an injection molding process.

The reflective layer 43 is disposed between the cover layer 41 and the substrate 42. In the current embodiment, the reflective layer 43 is made of metal or alloy, such as silver or silver alloy, aluminum or aluminum alloy, gold or gold alloy, semiconductor alloy film, and the likes. The reflective layer 43 is usually formed by sputtering or evaporation.

As described hereinabove, the manufacturers may dope the thermochromic dye in the substrate or print it on the surface of the optical recording medium for manufacturing the desired products of various specifications. Of course, the manufacturers can dope the thermochromic dye in the substrate and print it on the surface of the optical recording medium depending on the actual needs.

In summary, the optical recording medium of the invention utilizes a thermochromic dye to detect whether it is located in an unsuitable environment or not. When the environmental temperature is unsuitable, the warning symbol appears on the optical recording medium for alerting the user. In addition, since the optical recording medium of the invention can show different colors in different environmental temperatures, it can provide better entertainment and uniqueness so as to cause the purchases of customers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical recording medium, comprising:
a first substrate;
a second substrate, which includes a thermochromic dye; and
a reflective layer, which is disposed between the first substrate and the second substrate.

2. The optical recording medium of claim 1, wherein the thermochromic dye is doped in the second substrate.

3. The optical recording medium of claim 2, wherein the thermochromic dye is approximate 0.1 to 0.3% of the second substrate.

4. The optical recording medium of claim 1, wherein the thermochromic dye forms a meaningful pattern or a word.

5. The optical recording medium of claim 1, wherein the thermochromic dye is applied on a surface of the second substrate.

6. The optical recording medium of claim 5, wherein the thermochromic dye is mixed with ink and then printed on the surface of the second substrate.

7. The optical recording medium of claim 6, wherein the thermochromic dye is approximate 1 to 10% of the ink.

8. The optical recording medium of claim 1, wherein the thermochromic dye comprises CoCl2-2C6H12N4-10H20, HgI2, or thermochromic microcapsule dye.

9. The optical recording medium of claim 1, wherein the optical recording medium is a DVD-ROM, DVD±R, a DVD±RW, a DVD-RAM, or an HD-DVD.

10. An optical recording medium, comprising:
a substrate;
a reflective layer, which is disposed on a surface of the substrate; and
a printing layer, which is disposed on a surface of the reflective layer and includes a thermochromic dye.

11. The optical recording medium of claim 10, wherein the thermochromic dye is mixed with ink to form the printing layer, and the thermochromic dye is approximate 1 to 10% of the ink.

12. The optical recording medium of claim 10, wherein the thermochromic dye comprises CoCl2-2C6H12N4-10H20, HgI2, or thermochromic microcapsule dye.

13. The optical recording medium of claim 10, wherein the optical recording medium is a CD, a CD-R, or a CD-RW.

14. The optical recording medium of claim 10, wherein the thermochromic dye forms a meaningful pattern or a word.

15. An optical recording medium, comprising:
a cover layer;
a substrate, which includes a thermochromic dye; and
a reflective layer, which is disposed between the cover layer and the substrate.

16. The optical recording medium of claim 15, wherein the thermochromic dye is doped in the substrate.

17. The optical recording medium of claim 16, wherein the thermochromic dye is approximate 0.1 to 0.3% of the substrate.

18. The optical recording medium of claim 15, wherein the thermochromic dye is applied on a surface of the substrate.

19. The optical recording medium of claim 18, wherein the thermochromic dye is mixed with ink and then printed on the surface of the substrate, and the thermochromic dye is approximate 1 to 10% of the ink.

20. The optical recording medium of claim 15, wherein the thermochromic dye comprises CoCl2-2C6H12N4-10H20, HgI2, or thermochromic microcapsule dye.

21. The optical recording medium of claim 15, wherein a light beam passes through the cover layer for reading data from the optical recording medium, writing data into the optical recording medium, or erasing data of the optical recording medium.

22. The optical recording medium of claim 15, wherein the optical recording medium is a blu-ray disc.

23. The optical recording medium of claim 15, wherein the thermochromic dye forms a meaningful pattern or a word.
